(19) United States
(12) Patent Application Publication
(10) Pub. No.: US 2018/0009482 A1
(43) Pub. Date: Jan. 11, 2018

(54) A seamless Unibody Structure of a C-Pillar for vehicles

(71) Applicant: MAHINDRA AND MAHINDRA LIMITED, Mumbai (IN)

(72) Inventors: Arifulla ATTAR, Mumbai (IN); Nitin Suresh NIGUL, Mumbai (IN); Sachin Arun KASAR, Mumbai (IN); Imran HUSSAIN, Mumbai (IN)

(21) Appl. No.: 15/540,824

(22) PCT Filed: Dec. 22, 2015
(86) PCT No.: PCT/IB2015/059863

§ 371 Date: Jun. 29, 2017

(30) Foreign Application Priority Data
Dec. 29, 2014 (IN) 4210/MUM/2014

(51) Int. Cl. B62D 25/04; B62D 25/20; B62D 25/06; B62D 25/16; B62D 27/02; B62D 25/24

(52) U.S. Cl. CPC B62D 25/04; B62D 27/02; B62D 25/24; B62D 25/06; B62D 25/16; B62D 25/2036

(57) ABSTRACT

A seamless unibody structure of C-pillar for vehicles is envisaged. The seamless unibody structure has an operative top end and an operative bottom end, and is defined by a C-pillar inner, a C-pillar extension portion and a wheel house inner. The C-pillar inner extends from the operative top end. The C-pillar extension portion extends integrally from the C-pillar inner, and the wheel house inner extends integrally from the C-pillar extension portion.

### FIELD

The present disclosure relates to the field of mechanical engineering. Particularly, the present disclosure relates to the field of vehicles.

### DEFINITIONS

The expression ‘Quarter Panel’ used hereinafter in the specification refers to but is not limited to a body panel (exterior surface) of an automobile between a rear and the trunk and typically wraps around the wheel well.

The expression ‘C-pillar’ used hereinafter in the specification refers to but is not limited to a vertical support separating a car's rear window from the car's rear windscreen.

The expression ‘C-pillar inner’ used hereinafter in the specification refers to but is not limited to the operative top portion of the C-pillar.

The expression ‘Wheel house inner’ used hereinafter in the specification refers to but is not limited to the operative bottom portion of the C-pillar that is configured to partially surround the wheel of the vehicle.

The expression ‘C-pillar extension’ used hereinafter in the specification refers to but is not limited to the portion of the C-pillar extending between the C-pillar inner and the wheel house inner.

The expression ‘lift gate’ used hereinafter in the specification refers to but is not limited to an access door for an enclosure at the rear of a vehicle that can be mechanically raised during loading and unloading of cargo.

These definitions are in addition to those expressed in the art.

### BACKGROUND

In vehicles, quarter panels are supporting structures disposed at rear portions of the vehicles. Quarter panels provide body-side torsion stiffness to the vehicle. Quarter panels have a first portion which is in interface with the rear door, a second portion which is in interface with the lift gate, an operative bottom portion which is in interface with the under body and an operative top portion which is in interface with the roof.

Conventional quarter panels have C-pillars which are typically formed by assembling C-pillar inners, wheel house inners, and C-pillar extension portions (lady leg). Typically, the C-pillar inners, the wheel house inners, and the C-pillar extension portions are assembled together by weld joints. Also, in the typical C-pillars, approximately seven to eight molding dies are required for the manufacturing the C-pillar inners, the wheel house inners, and the C-pillar extension portions. The requirement of welding as well as the molding dies leads to an increase in the cost. Also, separate molding of the C-pillar inners, the wheel house inners, and the C-pillar extension portions produces a large amount of scrap material.

Hence, there is a need to alleviate the aforementioned drawbacks associated with conventional C-pillars.

### OBJECTS

Some of the objects of the present disclosure, which at least one embodiment herein satisfies, are as follows:

An object of the present disclosure is to provide a unibody structure of a C-pillar for a vehicle that is a single piece seamless structure with an integrated C-pillar inner, a wheel house inner, and a C-pillar extension portion.

Another object of the present disclosure is to provide a unibody structure of a C-pillar for a vehicle that is a seamless structure which results in providing comparatively higher strength to the C-pillar.

Other objects and advantages of the present disclosure will be more apparent from the following description, which is not intended to limit the scope of the present disclosure.

### SUMMARY

The present disclosure envisages a seamless unibody structure of a C-pillar for vehicles. The seamless unibody structure has an operative top end and an operative bottom end and is defined by a C-pillar inner, a C-pillar extension portion and a wheel house inner. The C-pillar inner extends from the operative top end. The C-pillar extension portion extends integrally from the C-pillar inner, and the wheel house inner extends integrally from the C-pillar extension portion.

The seamless unibody structure has a roof flange extending from the operative top end of the structure to facilitate connection of the structure to a roof of the vehicle. It also has an underbody flange extending from the wheel house inner to facilitate connection of the seamless unibody structure to a floor of the vehicle. Further, the seamless unibody structure has a rear door flange extending therefrom to facilitate connection of the structure to a rear door of the vehicle.

### BRIEF DESCRIPTION OF THE ACCOMPANYING DRAWING

A seamless unibody structure of a C-pillar for a vehicle of the present disclosure will now be described with the help of the accompanying drawing, in which:

FIG. 1a illustrates a schematic representation of a conventional C-pillar;

FIG. 1b illustrates a schematic representation of another conventional C-pillar;

FIG. 1c illustrates a schematic representation of yet another conventional C-pillar;

FIG. 2a illustrates a perspective inner view of a seamless unibody structure of a C-pillar a vehicle, in accordance with an embodiment of the present disclosure;

FIG. 2b illustrates an enlarged perspective inner view of the seamless unibody structure of the C-pillar of FIG. 2a;

FIG. 2c illustrates a perspective outer view of the seamless unibody structure of the C-pillar of FIG. 2a;

FIG. 3 illustrates a schematic representation of the seamless unibody structure of the C-pillar of FIG. 2a;

FIG. 4a illustrates a perspective view of the seamless unibody structure of the C-pillar of FIG. 2a;

FIG. 4b illustrates another perspective view of the seamless unibody structure of the C-pillar of FIG. 2a;

FIG. 5a illustrates a perspective view of the seamless unibody structure of the C-pillar of FIG. 2a in interface with a rear door of the vehicle;

FIG. 5b illustrates a perspective view of the seamless unibody structure of the C-pillar of FIG. 2a in interface with the lift gate of the vehicle;

FIG. 5c illustrates a perspective view of the seamless unibody structure of the C-pillar of FIG. 2a in interface with the floor of the vehicle; and

FIG. 5d illustrates a perspective view of the seamless unibody structure of the C-pillar of FIG. 2a in interface with the roof of the vehicle.

### DETAILED DESCRIPTION

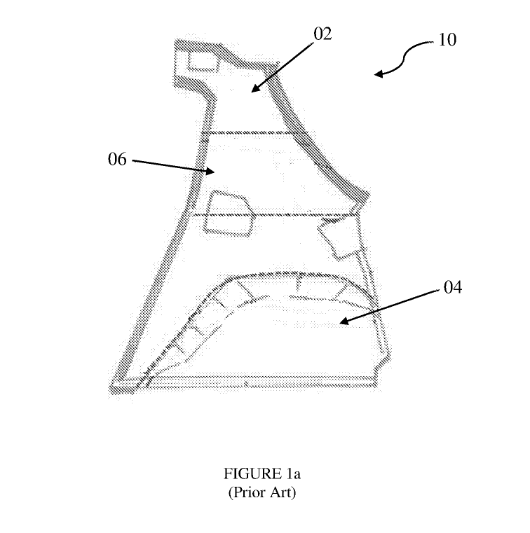

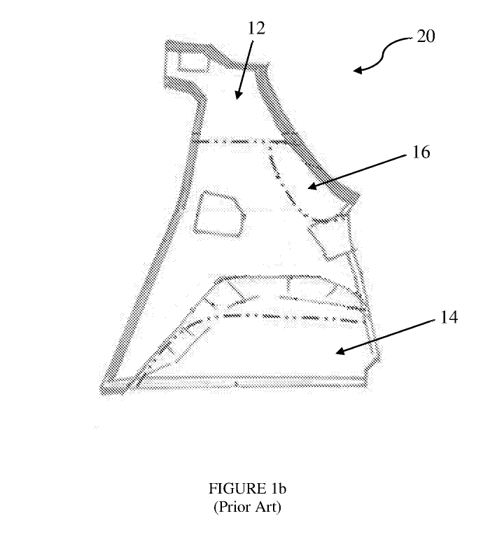

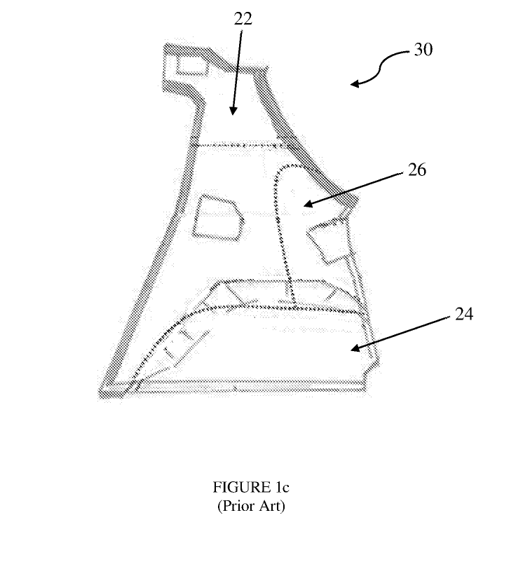

FIG. 1a illustrates a perspective view of a conventional C-pillar 10. The conventional C-pillar 10 is formed by primarily assembling a C-pillar inner 02, a wheel house inner 04, and a C-pillar extension portion 06.

FIG. 1b illustrates a perspective view of another conventional C-pillar 20. The conventional C-pillar 20 is formed by assembling a C-pillar inner 12, a wheel house inner 14, and a C-pillar extension portion 16.

FIG. 1c illustrates a perspective view of a conventional C-pillar 30. The conventional C-pillar 30 is formed by assembling a C-pillar inner 22, a wheel house inner 24 and a C-pillar extension portion 26.

Each of the C-pillar inners 02, 12, and 22, the wheel house inners 04, 14, and 24, and the C-pillar extension portions 06, 16, and 26 require separate molding dies. Approximately, 3 to 4 dies are required for each of the wheel house inners 04, 14, and 24, and the C-pillar extension portions 06, 16, and 26, which leads to increase in molding cost. The cost further increases as an individual technician is required to operate each die molding machine. Additionally, the material handling time and cost associated with the molding process is comparatively more.

Furthermore, the respective C-pillar inners 02, 12, and 22, the respective wheel house inners 04, 14, and 24, and the respective C-pillar extension portions 06, 16, and 26 are welded to form the respective C-pillars 10, 20, and 30. Separate technicians are required to perform the welding. The welding process requires the use of welding fixtures and causes excessive power consumption, thereby increasing the cost associated therewith. Further, the welded areas are more likely to get corroded due to moisture ingress. Also, as each of the C-pillar inners 02, 12, and 22, the wheel house inners 04, 14, and 24, and the C-pillar extension portions 06, 16, and 26 are separately molded, a large amount of scrap/waste material is produced.

Hence, there is a need of a C-pillar which alleviates some of the drawbacks associated with the conventional C-pillar.

The present disclosure discloses a unibody structure of the C-pillar for the vehicle which is a single piece seamless structure with an integrated C-pillar inner, a wheel house inner, and a C-pillar extension portion. The seamless unibody structure of the C-pillar provides adequate stiffness to the rear portion of the vehicle. The seamless unibody structure of the C-pillar substantially reduces the likelihood of corrosion due to moisture.

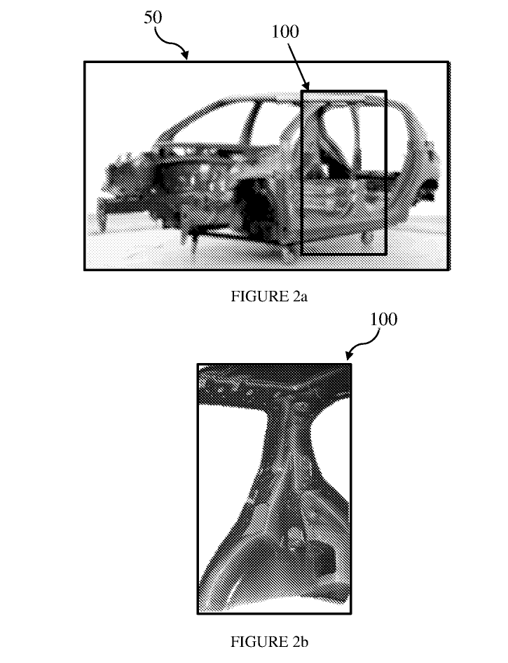

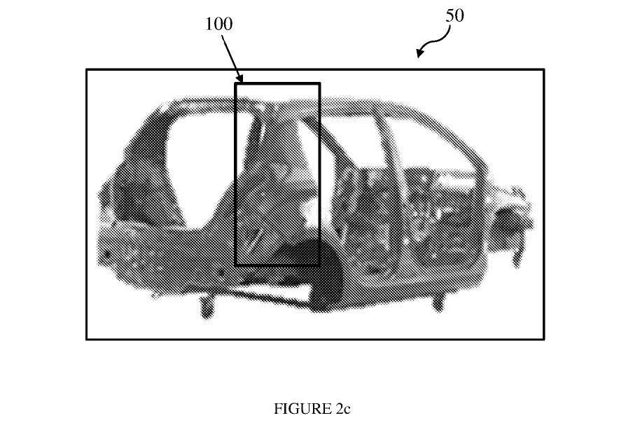

FIG. 2a and FIG. 2b illustrate a photographic view of an inner portion of the seamless unibody structure of a C-pillar 100 connected to a body in white 50 of a vehicle, in accordance with one embodiment of the present disclosure. FIG. 2c illustrates a photographic view of an outer portion of the seamless unibody structure of the C-pillar 100.

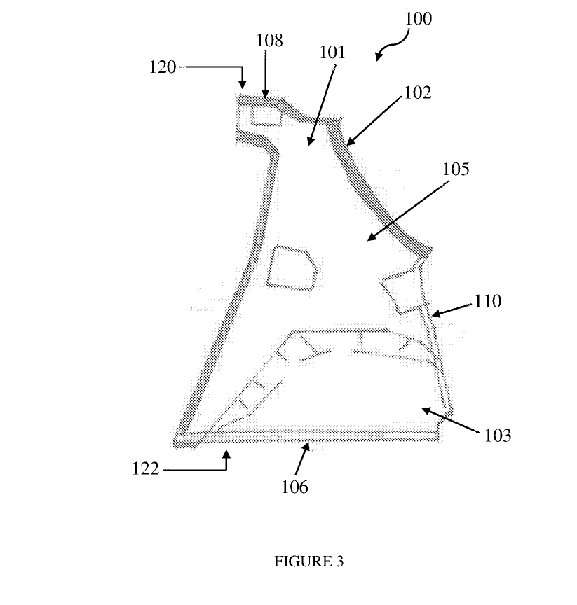

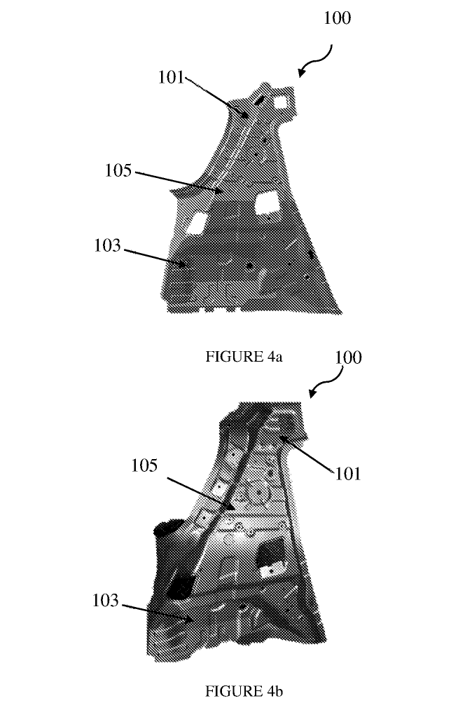

FIGS. 3, 4a, and 4b of the accompanying drawing illustrate the details of the seamless unibody structure of the C-pillar 100. The seamless unibody structure of the C-pillar 100 has an operative top end 120 and an operative bottom end 122 and extending between a roof and a floor of the vehicle. The operative top end 120 is connectable to the roof and the operative bottom end 122 is connectable to the floor. The seamless unibody structure of the C-pillar 100 is defined by a C-pillar inner 101, a wheel house inner 103, and a C-pillar extension portion 105. The C-pillar inner 101 extends from the operative top end 120. The C-pillar extension portion 105 extends integrally from the C-pillar inner 101, and the wheel house inner 103 extends integrally from the C-pillar extension portion 105.

The seamless unibody structure of the C-pillar 100 has an integral tail gate seal flange 102, a rear door flange 104, an underbody flange 106, a roof flange 108, and a C-pillar extension flange 110 configured thereon.

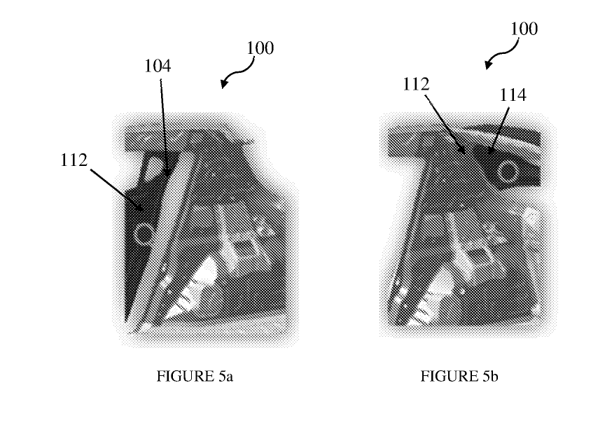

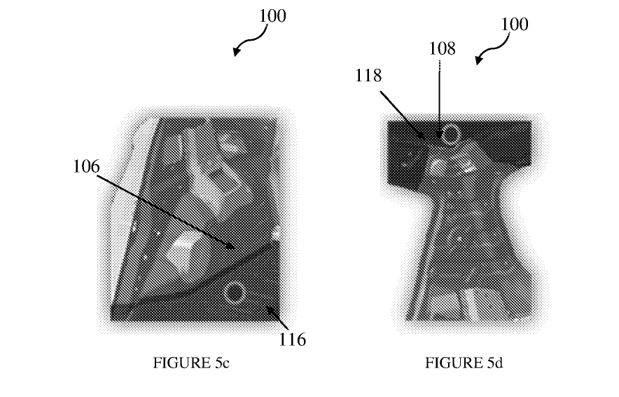

FIG. 5a illustrates an isometric view wherein the rear door flange 104 of the seamless unibody structure of the C-pillar 100 extends therefrom to facilitate the connection of the seamless unibody structure of the C-pillar 100 to a rear door 112 of the vehicle. FIG. 5b illustrates an isometric view wherein the tail gate seal flange 102 of the seamless unibody structure of the C-pillar 100 in is interface with a lift gate 114 of the vehicle. FIG. 5c illustrates an isometric view wherein the underbody flange 106 of the seamless unibody structure of the C-pillar 100 extends from the wheel house inner 103 to facilitate connection of the seamless unibody structure of the C-pillar 100 to a floor 116 of the vehicle. FIG. 5d illustrates an isometric view wherein the roof flange 108 of the seamless unibody structure of the C-pillar 100 extends from the operative top end 120 to facilitate the connection of the seamless unibody structure of the C-pillar 100 to a roof 118 of the vehicle.

Additionally, the seamless unibody structure of the C-pillar 100 has provisions for accommodating various packaging components such as trims, rear seat belts, electrical routings, seat ELR mountings, hand accesses to fit fuel plunger at panel fuel filler. Further, the seamless unibody structure of the C-pillar 100 has provisions (such as a provision for welding the roof flange 108 with the roof 118, a provision for peripheral weldings and the like) through which welding, typically spot welding, may be performed. In an embodiment, the seamless unibody structure of the C-pillar 100 has provisions of fastening (such as a provision for fastening the roof flange 108 to the roof 118). Further, the seamless unibody structure of the C-pillar 100 has at least one clearance such as a rear passenger head clearance, a fuel plunger hand access clearance, a welding gun access clearance, an ELR unit clearances and the like.

The seamless unibody structure of the C-pillar 100 owing to the single seamless structure with an integrated C-pillar inner 101, a wheel house inner 103 and a C-pillar extension portion 105 requires a single molding die, and hence, eliminates the need of three separate dies for the C-pillar inners 02, 12, and 22, the wheel house inners 04, 14, and 24, and the C-pillar extension portions 06, 16, and 26, as required in case of the conventional C-pillars 10, 20, and 30.

Due to reduction in number of dies used for molding the seamless unibody structure of the C-pillar 100, molding cost is reduced. Also, the seamless unibody structure of the C-pillar 100 owing to the single seamless structure eliminates the need of weld joints. Elimination of weld joints eliminates the requirement of fixtures, welding tools used for welding, power consumption during welding, manpower required for welding, production time required for welding, material handling and thereby enables in reducing cost associated there-with. Also, owing to seamless structure the likelihood of corrosion which may occur at seams when subjected to moisture is reduced.

Further, producing a single seamless structure enables minimization of scrap production. Also, the paint sealer cost and the spot sealer cost are comparatively reduced. Due to elimination of seams/joints, the seamless unibody structure of the C-pillar is of comparatively higher strength.

The seamless unibody structure of the C-pillar 100 is in compliance with the requirement of the Noise, Vibration and Harshness (NVH) standards. The seamless unibody structure of the C-pillar 100 meets the durability targets such as torsional stiffness and bending stiffness, seat belt anchorage pull tests and the like. The seamless unibody structure of the C-pillar 100 meets the computer aided engineering (CAE) targets. Also, owing to seamless unibody structure of the C-pillar 100, i.e., having integrated C-pillar inner 101, the wheel house inner 103, and the C-pillar extension portion 105, the seamless unibody structure of the C-pillar 100 has comparatively more Percentage Inspection Points that Satisfy Tolerance (PIST), and hence, the accuracy of mounting of the seamless unibody structure of the C-pillar 100 is more than 95%.

### TECHNICAL ADVANCEMENTS

The present disclosure described herein above has several technical advantages including, but not limited to, the realization of:
a unibody structure of a C-pillar for a vehicle that is a single piece seamless structure with an integrated C-pillar inner, a wheel house inner, and a C-pillar extension portion; and
a unibody structure of a C-pillar for a vehicle that is a seamless structure which results in providing comparatively higher strength to the C-pillar.

The present disclosure is described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A seamless unibody structure of a C-pillar for a vehicle, said structure extending between a roof and a floor of the vehicle, said structure having an operative top end connectable to said roof and an operative bottom end connectable to said floor, said structure defined by:
a C-pillar inner extending from said operative top end;
a C-pillar extension portion extending integrally from said C-pillar inner; and
a wheel house inner extending integrally from said C-pillar extension portion.

2. The structure as claimed in claim 1, wherein said structure has a roof flange extending from said operative top end of said structure to facilitate connection of said structure to said roof.

3. The structure as claimed in claim 1, wherein said structure has an underbody flange extending from said wheel house inner to facilitate connection of said structure to said floor.

4. The structure as claimed in claim 1, wherein said structure has a rear door flange extending therefrom to facilitate connection of said structure to a rear door of said vehicle.

5. The structure as claimed in claim 1, wherein said structure has a tail gate seal flange configured thereon to facilitate interface of said structure with a lift gate of said vehicle.
